(19) United States
(12) Patent Application Publication
(10) Pub. No.: US 2016/0103567 A1
(43) Pub. Date: Apr. 14, 2016

(54) USER INTERFACE AND METHOD FOR ADAPTING A MENU BAR ON A USER INTERFACE

(71) Applicant: VOLKSWAGEN AG, Wolfsburg (DE)

(72) Inventors: Heino WENGELNIK, Wolfsburg (DE); Frank ALTHOFF, Lehrte (DE); Maria Esther MEJIA GONZALEZ, Braunschweig (DE)

(21) Appl. No.: 14/878,633

(22) Filed: Oct. 8, 2015

(30) Foreign Application Priority Data
Oct. 8, 2014 (EP) 14188031.0

(51) Int. Cl. G06F 3/0482; G06F 3/0484; G06F 3/0485; G06F 3/0481; G06F 3/0488

(52) U.S. Cl. CPC G06F 3/0482; G06F 3/04817; G06F 3/0488; G06F 3/0485; G06F 3/04842

(57) ABSTRACT

A user interface and a method for adapting a menu bar on a user interface. The method includes displaying the menu bar on a display unit of the user interface, receiving a first user input for displaying a two-dimensional arrangement in the menu bar of displayable entries representing ranges of functions of the user interface, displaying the arrangement on the display unit, receiving a second predefined user input with respect to an entry of the menu bar or an entry of the arrangement, and, in response thereto, adapting the menu bar.

### PRIORITY CLAIM

This patent application claims priority to European Patent Application No. 14188031.0, filed 8 Oct. 2014, the disclosure of which is incorporated herein by reference in its entirety.

### SUMMARY

Illustrative embodiments relate to a user interface and to a method for adapting a menu bar on a user interface. In particular, user interfaces of means of locomotion are addressed which offer an extensive range of functions on an optical display of the user interface.

### BRIEF DESCRIPTION OF THE DRAWINGS

In the text which follows, illustrative embodiments are described in detail with reference to the attached drawings. In the drawings:

FIG. 1 shows a diagrammatic overview of the components of a disclosed embodiment of a user interface in a disclosed embodiment of a means of locomotion;

FIG. 2 is a diagrammatic view of a disclosed embodiment of a user interface in a disclosed embodiment of a user terminal;

FIGS. 3, 4 and 5 are illustrations of operating steps and their result in the operation of a user interface designed; and

FIG. 6 is a flowchart illustrating steps of a disclosed embodiment of a disclosed method.

### DETAILED DESCRIPTION OF THE DISCLOSED EMBODIMENTS

Disclosed embodiments provide a method for adapting a menu bar on a user interface and by a corresponding user interface. In a first step, a menu bar is represented on a display unit of the user interface. The display unit can be, for example, a screen which can be designed as combined instrument, as central information display (CID) or as touch screen of a mobile user terminal. The menu bar has entries which represent ranges of functions or families of functions, respectively, of the user interface. In a further step, a first user input for displaying a two-dimensional application is received, the two-dimensional arrangement having entries arranged, for example, in columns and lines, which also represent ranges of functions of the user interface. The two-dimensional arrangement has, in particular, a higher number of entries than the menu bar. Following this, the two-dimensional arrangement is displayed on the display unit and a second predefined user input with respect to an entry of the menu bar or an entry of the arrangement is received. In other words, the user selects either an entry within the menu bar or an entry in the two-dimensional arrangement to supplement or to reduce the entries arranged in the menu bar. Whilst the menu bar provides for a rapid optional access to the ranges of functions represented by it, the two-dimensional arrangement provides for an optional adaptation of the ranges of functions represented in the menu bar. In this manner, an optional, flexible and rapid adaptation of the entries contained in the menu bar can be performed. As a result, the traveling safety or traffic safety, respectively, is increased when using the user interface.

The menu bar can be arranged, in particular, along an edge area of the display unit. For example, it can be arranged vertically at the left-hand or right-hand edge, respectively, of the display unit or horizontally at the upper or at the lower edge, respectively, of the display unit so that the unidimensional lining up of entries contained in it arranges these above one another or next to one another. As an alternative, it is also possible to arrange the menu bar between two components of a so-called, split screen (divided screen display) and delimit the two screen areas from one another optically by the menu bar. In the latter arrangement, the paths of the wiping gestures which must be performed for any assignment of contents by means of the entries of the menu bar are reduced.

The two-dimensional arrangement can contain, in particular, the totality of the entries which are basically displayable in the menu bar. In this context, the two-dimensional arrangement can extend over a single screen representation on the display unit or over a number of screen representations. Similar arrangements are known for the applications in the iOS operating systems or android, respectively, in another context. The first user input can be, for example, a wiping gesture which starts in an edge area of the display unit and is oriented in the direction of a central area of the display unit. In particular, the first user input can start on the menu bar and move it in the direction of the center of the display unit (drag gesture). In response thereto, the two-dimensional arrangement for configuration of the menu bar is displayed. In this manner, an intuitive adaptation of the menu bar is possible without having to call up predefined configuration menus.

The second user input, too, can be carried out as wiping gesture which starts on an entry of the menu bar and is oriented in the direction of the two-dimensional arrangement. By means of such a wiping gesture, the menu bar can be reduced by the corresponding entry. In particular, the entry is here not added to the two-dimensional arrangement since it was already contained previously in the two-dimensional arrangement. As an alternative or additionally, the second user input, the wiping gesture, can start on an entry of the two-dimensional arrangement and be oriented in the direction of the menu bar. In other words, the entry selected by the wiping gesture within the two-dimensional arrangement is added to the menu bar. Optionally, the second user input ends on the menu bar in this disclosed embodiment. In an alternative embodiment, the movement of the selected entry can be continued in accordance with a virtual inertia allocated to the entry and after the wiping gesture has been interrupted by lifting the finger away from the display unit before reaching the menu bar or before reaching the two-dimensional arrangement, respectively. This increases the efficiency in the operation since shorter movements can be used for achieving corresponding results.

The entries which are contained in unidimensional line up within the menu bar or in two-dimensional (grid) arrangement can comprise, in particular, icons for the ranges of functions or families of functions represented by them. However, this does not exclude a presence of short text components for improving the density of information. In particular, however, the icons, similar to those for applications of the known aforementioned operating systems for Smartphones, are not designed for displaying current data or for their reception. Instead, they are used for the constant illustration of the range of functions and its call up during movement on configurable display/operating elements within the graphical user interface.

Optionally, the menu bar itself can be configured to appear only in response to a wiping gesture of a user on the display unit of the user interface. For example, the menu bar can be completely hidden at a first time or only announced by a discrete note (e.g. “glow”) in the edge area of the screen representation and displayed by a wiping gesture starting in the area of this note and oriented towards the center of the screen. As a result, the unidimensional arrangement of the entries appears whilst a continued execution of the wiping gesture or a repeated execution of the wiping gesture also causes the two-dimensional arrangement for its adaptation to appear in addition to the menu bar.

According to a second disclosed embodiment, a user interface for adapting a menu bar on a display unit of a means of locomotion is proposed. This comprises the display unit for displaying the menu bar, wherein the menu bar can be configured in accordance with the preceding statements. An input unit is provided for receiving user inputs. The input unit can represent a touch-sensitive (transparent) surface of the display unit of the user interface. Alternatively or additionally, the input unit can comprise units for detecting and evaluating (3D-) gestures carried out freely in space. For wiping gestures carried out as 3D-gestures, the starting/target points of the respective wiping movement are obtained for positions of the input area which correspond to the above-mentioned positions on the display unit. An evaluating unit is provided for evaluating user inputs and can comprise a programmable processor, a controller or the like. The display unit is configured to display, in response to a first user input, a two-dimensional arrangement in the menu bar of displayable entries. In response to a second predefined user input with respect to an entry of the menu bar or an entry of the arrangement, the display unit displays a correspondingly adapted menu bar (reduced or supplemented by an entry, respectively).

The feature and combinations of features resulting from these correspond to the statements made in conjunction with the first-mentioned embodiment of the present disclosure obviously in such a manner that reference is made to the above disclosure to avoid repetitions.

According to a third disclosed embodiment, a user terminal (e.g. a Smartphone, a tablet PC or another mobile wireless communication device) is proposed which comprises a user interface in accordance with the disclosed embodiment mentioned secondly. In this case, the entries in the menu bar or in the two-dimensional arrangement, respectively, are representative of the ranges of functions of the user terminal.

According to a fourth disclosed embodiment, a computer program product (e.g. a data memory) is proposed on which instructions are stored which enable a programmable processor of a user interface to perform the steps of a method according to the disclosed embodiment mentioned first. The computer program product can be designed as CD, DVD, Blu-ray disk, flash memory, hard disk, RAM/ROM, cache etc.

According to a fifth disclosed embodiment, a signal sequence representing instructions is proposed which enable a programmable processor of a user interface to perform the steps of a method according to the disclosed embodiment mentioned first. In this manner, the information-technical provision of the instructions is also placed under protection for the case that the storage means required for this purpose are outside the range of validity of the attached claims.

According to a sixth disclosed embodiment, a means of locomotion (e.g. a passenger car, a transporter, a lorry, a water- and/or aircraft) is proposed which comprises a user interface according to the disclosed embodiment mentioned secondly. In this case, the entries of the menu bar or of the two-dimensional arrangement, respectively, represent ranges of functions of the means of locomotion.

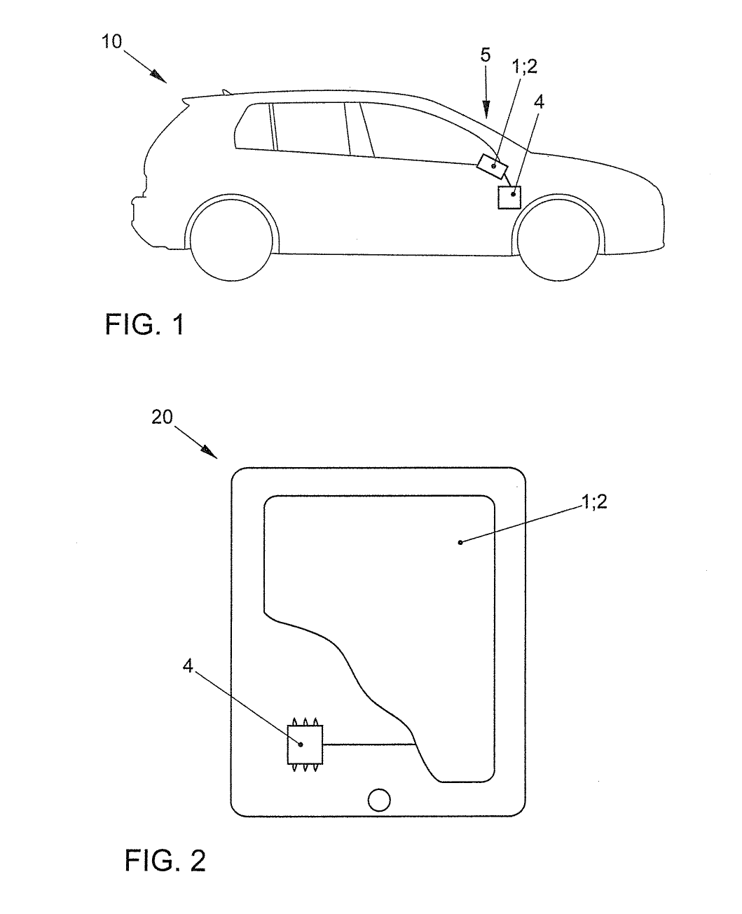

FIG. 1 shows a passenger car 10 as means of locomotion which has a user interface for adapting a menu bar on a display unit 1. The display unit is provided with a transparent touch-sensitive surface 2 as input unit and information-technically connected to an electronic control device 4 as evaluating unit.

FIG. 2 shows a tablet PC 20 as mobile wireless communication device which has a touch screen 1, 2 as input or display unit, respectively. The user gestures input by the touch-sensitive surface are received by a microprocessor 4 as evaluating unit and are taken to initiate an adapted representation of the menu bar.

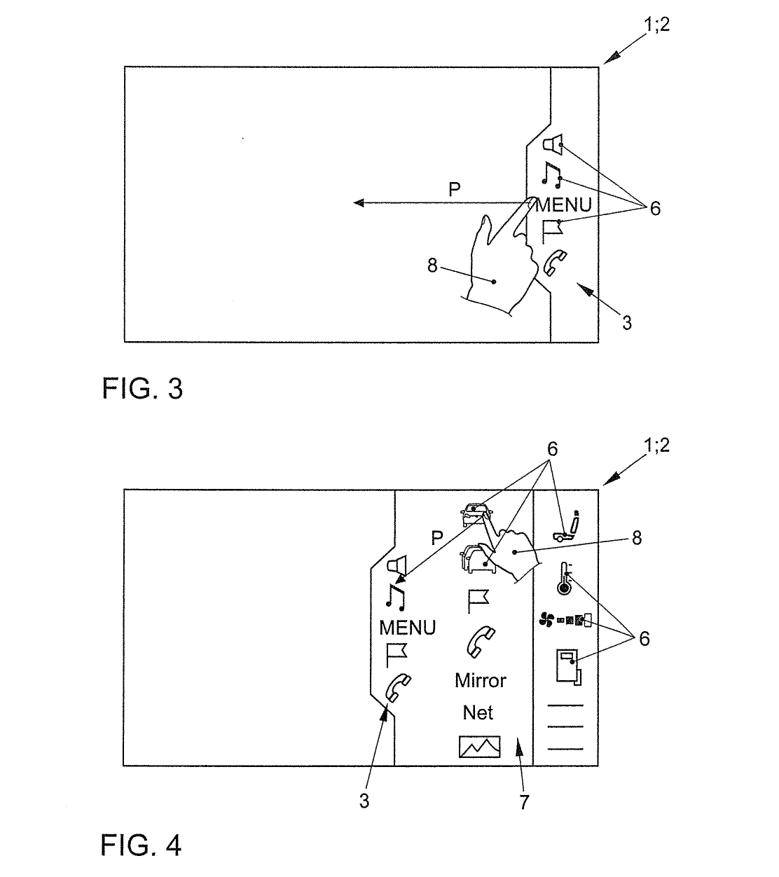

FIG. 3 shows a first operating step on a display/operating unit 1, 2 in which a user undertakes with his hand 8, beginning on a menu bar 3 arranged at the right-hand edge, along arrow P in the direction of the center of the screen, an operating step for the display of a two-dimensional arrangement. At this time, the menu bar only has four entries 6 representing different ranges of functions. Furthermore, the text “MENU” is shown on the menu bar which enables the two-dimensional arrangement to be represented by a tipping gesture.

FIG. 4 shows the result of the user interaction shown in FIG. 3, by means of which two further columns and eight lines of different entries 6 have been brought to appear on the right next to the menu bar 3. The entries 6 of the two columns are component of a two-dimensional arrangement 7 (also called grid) on which the hand 8 of the user selects vehicle functions to add them to the menu bar 3 by a wiping gesture oriented along the arrow P.

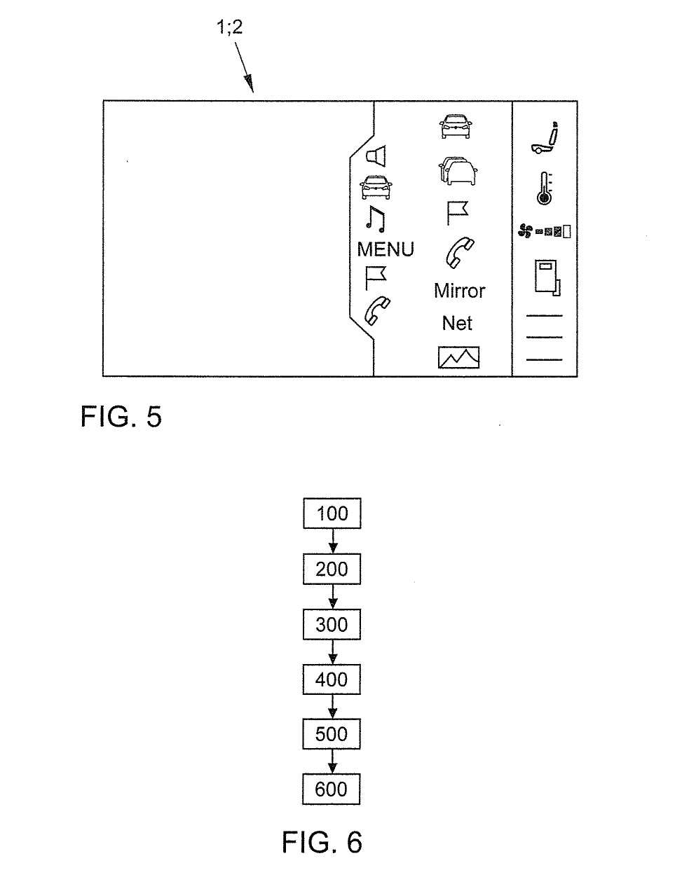

FIG. 5 shows the result of the operating step illustrated in FIG. 4. The menu bar 3 now additionally has a symbol 6 representing the functions of the on-board computer. The two-dimensional arrangement 7 also still has this entry 6 since it is supposed to always keep available all ranges of functions of the means of locomotion illustrated by the entries 6.

FIG. 6 shows method steps of an illustrative embodiment of a method for adapting a menu bar on a user interface. In step 100, the input unit receives a wiping gesture of a user in response to which the menu bar is displayed on a display unit of the user interface in step 200. In step 300, the input unit receives a first user input for displaying a two-dimensional arrangement of entries displayable in the menu bar, representing ranges of functions of the user interface. In step 400, the two-dimensional arrangement is displayed on the display unit. In step 500, a second predefined user input with respect to an entry of the menu bar is received, that is to say detected and evaluated, in response to which the menu bar is reduced by the entry in step 600.

Entries contained in the menu bar can be understood as “link” or “short cut” via which freely configurable display/operating areas (e.g. “tiles”) can be configured (e.g. by means of drag and drop gestures). In other words, the area of functions represented by the entry can be assigned by drawing in to the entries of a tile or another display area (split screen or the like). After the successful assignment, the functions represented can be used for displaying current data or receiving corresponding user inputs. Operating a generic user interface is made more efficient. In particular, its configuration is facilitated as a result of which the traffic safety is impaired less during the operation than in accordance with the prior art.

Even though the disclosed embodiments are explained in conjunction with the attached figures of the drawings, modifications and combinations of features of the disclosed embodiment shown are possible for the expert without departing from the scope of which is defined by the claims.

In the prior art, user interfaces for vehicles and mobile user devices are known which represent an extensive range of functions on an optical display. In this context, the available surface is always limited which is why only a selection of the accessible functions is always currently represented for the sake of clarity. A user-specific configuration of the ranges of functions shown is also known in the prior art. For example, a rigid menu bar is used for access to different families of functions in a current user operating concept by Tesla Motors. Even a displaceably designed menu bar on which different icons representing different families of functions are lined up in a unidimensional extension cannot guarantee a rapid access to all families of functions of the user interface. To access optional contents of the system it may therefore be required to call up a multiplicity of menu points until the desired range of functions can be viewed or operated, respectively. In this manner, the attention of the user is distracted from the traffic event especially during the operation of a means of locomotion. Disclosed embodiments provide efficiency of operation of a generic user interface to increase traffic safety.

### LIST OF REFERENCE DESIGNATIONS

1 Display unit
2 Input unit
3 Menu bar
4 Evaluating unit
5 User interface
6 Entries
7 Two-dimensional arrangement
8 Hand of the user
10 Passenger car
20 Tablet PC
100 to 600 Method steps
P Arrow

1. A method for adapting a menu bar on a user interface, the method comprising the steps:
displaying the menu bar on a display unit of the user interface,
receiving a first user input for displaying a two-dimensional arrangement in the menu bar of displayable entries representing ranges of functions of the user interface;
displaying the arrangement on the display unit;
receiving a second predefined user input with respect to an entry of the menu bar or an entry of the arrangement; and
in response thereto, adapting the menu bar.

2. The method of claim 1, wherein the menu bar (3) is a unidimensional lining up of entries (6) which, in particular, is arranged along an edge area of the display unit (1).

3. The method of claim 1, wherein the two-dimensional arrangement contains the totality of entries displayable in the menu bar.

4. Method according to one of the preceding claims The method of claim 1, wherein the first user input is a wiping gesture which starts in an edge area of the display unit and is oriented in the direction of a central area of the display unit.

5. The method of claim 1, wherein the second user input is a wiping gesture,
which starts on an entry of the menu bar and is oriented in the direction of the two-dimensional arrangement, and/or
which starts on an entry of the two-dimensional arrangement and is oriented in the direction of the menu bar.

6. The method of claim 1, wherein the second user input is a wiping gesture which starts on an entry of the menu bar and is oriented in the direction of a two-dimensional arrangement, and the adapting of the menu bar comprises a removing of the entry from the menu bar.

7. The method of claim 1, wherein the second user input is a wiping gesture which starts on an entry of the two-dimensional arrangement and is oriented in the direction of the menu bar, and the adapting of the menu bar comprises an adding of the entry to the menu bar.

8. The method of claim 1, wherein the entries are icons.

9. The method of claim 1, further comprising:
receiving a wiping gesture of a user and in response thereto
displaying the menu bar on a display unit of the user interface.

10. A user interface for adapting a menu bar on a display unit of a locomotive vehicle, the user interface comprising,
the display unit for displaying the menu bar comprising entries representing ranges of functions of the user interface;
an input unit for receiving user inputs and
an evaluating unit for evaluating user inputs, wherein
the display unit is configured to display, in response to a first user input, a two-dimensional arrangement in the menu bar of displayable entries,
in response to a second predefined user input with respect to an entry of the menu bar or an entry of the arrangement, to display an adapted menu bar.

11. The user interface of claim 10, configured to carry out a method for adapting a menu bar on a user interface, the method comprising:
displaying the menu bar on a display unit of the user interface;
receiving a first user input for displaying a two-dimensional arrangement in the menu bar of displayable entries representing ranges of functions of the user interface;
displaying the arrangement on the display unit;
receiving a second predefined user input with respect to an entry of the menu bar or an entry of the arrangement; and
in response thereto, adapting the menu bar.

12. A user terminal, particularly a mobile wireless communication device, comprising a user interface according to claim 10, wherein the entries represent ranges of functions of the user terminal.

13. A computer program product, comprising instructions which, if they are carried out on an evaluating unit of a user interface according to claim 10, cause the evaluating unit to perform the steps of a method for adapting a menu bar on a user interface, the method comprising:
displaying the menu bar on a display unit of the user interface;
receiving a first user input for displaying a two-dimensional arrangement in the menu bar of displayable entries representing ranges of functions of the user interface;
displaying the arrangement on the display unit;
receiving a second predefined user input with respect to an entry of the menu bar or an entry of the arrangement; and
in response thereto, adapting the menu bar.

14. A signal sequence representing instructions which, if they are carried out on an evaluating unit of a user interface according to claim 10, cause the evaluating unit to perform the steps of
displaying the menu bar on a display unit of the user interface;
receiving a first user input for displaying a two-dimensional arrangement in the menu bar of displayable entries representing ranges of functions of the user interface;
displaying the arrangement on the display unit;
receiving a second predefined user input with respect to an entry of the menu bar or an entry of the arrangement; and
in response thereto, adapting the menu bar.

15. A means of locomotion, comprising a user interface according to claim 10, wherein the entries represent ranges of functions of the means of locomotion.
